(19) United States
(12) Patent Application Publication
(10) Pub. No.: US 2007/0019693 A1
(43) Pub. Date: Jan. 25, 2007

(54) Wireless power beaming to common electronic devices

(76) Inventor: David Silliman Graham, Mountain View, CA (US)

Correspondence Address: DAVID GRAHAM, 704 CALDERON AVENUE, MOUNTAIN VIEW, CA, 94041, US

(21) Appl. No.: 11/370,523

(22) Filed: Mar. 7, 2006

Related U.S. Application Data
(60) Provisional application No. 60/659,357, filed on Mar. 7, 2005.

(51) Int. Cl. H01S 3/00

(52) U.S. Cl. 372/38.09

(57) ABSTRACT

A method and apparatus for wireless power beaming consisting of a transmitter assembly (20), free space (40), and an optical-to-electric assembly (50). The transmitter assembly (20) has eye-safe lasers (26) that create a beam of light (90). The beam of light goes through free space (40) and impinges upon the surface of optical-to-electric assembly (50). Optical-to-electric assembly (50) has power conversion photodiode(s) (54) to convert the energy in the light (90) into electricity. Power Accounting (14) accounts for the power in the beam and controls the lasers to turn them off whenever radiation is not accounted for in the system.

### CROSS-REFERENCE TO RELATED APPLICATION(S)

This application claims the benefit of provisional patent application Ser. No. 40/659,357. filed 2005 Mar. 9 by the present inventor.

### FEDERALLY SPONSORED RESEARCH

Not applicable.

### SEQUENCE LISTING OR PROGRAM

Not applicable.

### BACKGROUND OF THE INVENTION

1. Field of the Invention

This invention relates to providing electrical power to electronic devices without a wire or other connection to a power source. It also relates to providing electronic signals to the device without a wire connection.

2. Prior Art

The current state-of-the-art in common home and business electrical and electronic devices is that they receive power from five types of sources.

1. Many are plugged into a wall outlet. An example would be a lamp with a power cord. In this case, the cord usually requires proximity to a wall outlet. It can get tangled or be tripped on. It may be unsightly. There may be insufficient outlets for all of the devices requiring power.

2. Some are plugged directly into another device. An example is a stereo speaker plugged into a stereo. In this case the wire must run from the stereo across the room to the speaker. This often involves a costly, difficult installation. To move the speaker later becomes difficult.

3. Others are operated by rechargeable batteries. Electric shavers, cordless drills, and cell phones fit this mode. This requires a power cord for recharging. In this case, there can be many cords. There may be more cords and chargers than there are convenient outlets, and batteries may run out at inconvenient times during use. This is usually limited to low-power devices.

4. Others are operated by disposable batteries. Travel alarm clocks and portable radios often operate this way. These devices cannot be very powerful. The batteries must be replaced.

5. A very few devices are powered by solar cells. The most common are inexpensive pocket calculators. These cannot be very powerful at all. As a result, solar cells are rarely used to power devices.

Currently no completely cordless solution for power to these kinds of common devices is available.

One solution to this is beamed power.

In the early 20^{th} century, Nicola Tesla wanted to send power over the air in large amounts, but he did not succeed¹.
¹http://www.pbs.org/tesla/

NASA has done experiments to transmit microwave power to a rectenna. The rectenna, or rectifying antenna, outputs DC electricity.² Microwaves have four disadvantages and one advantage compared to lasers. The disadvantages are substantial. First, they are intentional emitters under Federal Communications Commission regulations. They require licensing and bandwidth. Second, they can cause signal interference, and because they are regulated spectrum, any unwanted reflection will cause interference. Third, the components to contain them are not as easy to manufacture and work with as optical components. Fourth, they are unsafe around people. They can burn a person. Also, microwave radiation is also linked to cancer. Microwaves have one advantage: that they penetrate rain and fog better than light does.
²http://www.kurasc.kyoto-u.acjp/plasma-group/spshistory2-e.html

For more detail on microwave systems, please see the following patents:
Remote piloted vehicle powered by beamed radiation U.S. Pat. No. 6,542,253
Microwave-powered aircraft U.S. Pat. No. 5,503,350
Power-beaming system U.S. Pat. No. 5,068,669
Dual Polarization Reception and Conversion System U.S. Pat. No. 4,943,811
Orbiting Solar Power Station U.S. Pat. No. 4,078,447

NASA has used lasers to power a small model airplane as part of its studies of beaming power from space to earth and of keeping planes aloft for long periods of time.³ To do this, the experimenters put a 1 kW laser on a swivel and manually tracked a model airplane on a tether. They used non-eye-safe lasers in a manner that would not be safe or effective in a commercial application. These methods had no way to account for where the optical energy went, or if it was within FDA permitted limits.
³http://www.nasa.gov/centers/dryden/news/FactSheets/FS-087-DFRC.html

For more detail on laser or optical systems, please see the following patents:

Optically powered remote microdevices employing fiber optics U.S. Pat. No. 5,402,586 shows that devices can be powered at a distance by lasers. This system, however, requires that the device be connected to the laser by an optical fiber. Similar systems are sold by JDS-Uniphase, Inc.

Wireless power supply method U.S. Pat. No. 6,635,818 uses a visible light to drive a small micromachine. It does not provide sufficient power to drive a large load, like an audio speaker. It is not at an eye-safe wavelength. It does not have a system to assure that the human exposure remains within regulatory limits. It does not show a means of delivering the optical power beam to the photovoltaic cell.

Methods and apparatus for beaming power US Patent Application 20020056763 shows a system for beaming light to an airplane or other object. Basically it is a laser on a gimble, as demonstrated by NASA. It is not suitable for use in a home or business because it lacks precautions to allow a human not wearing eye-safety goggles nearby, and because it has no means to avoid being blocked generally. Line of sight is often not available in a home or business.

There is little prior art for use of a laser to power remote objects in the home or business because of safety issues, efficiency issues, and the difficulty of guaranteeing line-of-sight.

### OBJECTS AND ADVANTAGES

The objects of this invention are:
a) to safely provide power without cords or cables to common devices that usually have to be plugged-in;
b) to remove the inconvenience of battery charging and battery charging stations;
c) to reduce the congestion of wall outlets;
d) to provide signal along with power by the same channel wherever convenient.

Advantages of this invention are that it is convenient compared to attaching devices to walls with wires. It is more aesthetic—no rats-nested wires. It also enables entirely new applications. Examples might be lights made from balloons, with no attachment to any surface or clothes with built-in heating and cooling systems.

### SUMMARY

This invention consists of an apparatus and a method to transfer power without the use of wires, in a way that is safe for use in a location with people who are not taking precautions, such as an average household or office.

To transfer the power a transmitter assembly containing a laser(s) is plugged into an electrical socket. It uses its camera to search for an optical-to-electrical converter. When it finds a possible optical-to-electrical-converter, the transmitter assembly attempts to handshake with the optical-to-electrical-converter. In the preferred embodiment, the handshake consists of light pulses from the Transmitter and light pulses from a small photodiode of the receiver. When the handshake succeeds, the transmitter assembly and the optical-to-electrical-converter go through a Power Accounting algorithm. This algorithm assures that the Transmitter is safe to illuminate the optical-to-electrical-converter. If the result of the power accounting is positive, the Lasers are turned on. Then the Power Accounting algorithm executes continuously. When it no longer is positive, it turns off the lasers.

The apparatus for this method is as follows:

A transmitter assembly containing:
1. A high-efficiency, eye-safe, light source to transmit power. In the preferred embodiments, the source is an eye-safe laser(s).
2. Lens(es) for focusing and pointing the lasers. In the preferred embodiment, the outgoing light is nearly collimated, and the beam intensity is 1 mW/sq. mm-10 mW/sq.mm. The beam profile should be substantially uniform.
3. A mechanism for pointing the lasers. In one embodiment, this mechanism is powered and controlled from the CPU. It may be a powered pan-and tilt system. In an alternative embodiment, this mechanism is just a fixed pointing system. When a fixed pointing system is used, a visible indicator laser is used to facilitate pointing.
4. The transmitter part of the safety subsystem consisting of:
   a. a CMOS camera, such as a VGA camera from Kodak,
   b. an illumination light source that points along the same path as the camera
   c. a photodiode that is sensitive at the same wavelength as the optical-to-electrical converter's transmitter diode
   d. a monitor photodiode that is sensitive at the same wavelength as the power lasers and optics to image a fraction of the outgoing light onto the photodiode
   e. a CPU that controls the power lasers.
   d. software that accounts for the power in the beam
Free space in between the transmitter assembly and the receiver box. It may or may not contain mirrors to redirect the light.

An optical-to-electrical converter box containing:
1. One or more photodiodes. The best photodiodes depend on the nature of the load. For example, for the most efficient high-power conversion, Indium Phosphide diodes such as those from JDS-Uniphase are best. In one embodiment, these are used with lens(es) for focus-down. An example might be a TV. In another embodiment, such as for a cell phone, thin film photodiodes might be used with no focus down.
2. Optics to focus down onto the photodiodes. One embodiment has optics to focus-down the light. Another does not
3. The optical-to-electrical converter part of the safety subsystem consisting of:
   a. a light source. In the preferred embodiment, the light source is an 8500 nm VCSEL.
   b. Indicium. In the preferred embodiment, the indicium are made from retroreflective film, such as that from 3M.
   c. a circuit to monitor the current and voltage at the photodiodes.
   d. a CPU that controls the power lasers.
   e. software that accounts for the power in the beam

### DRAWINGS

### Figures

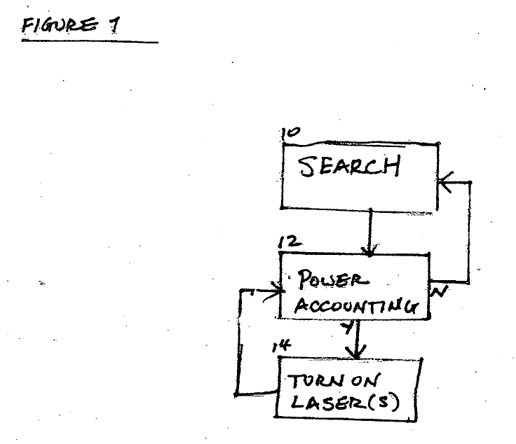

FIG. 1 shows a flow chart of the method of operation.

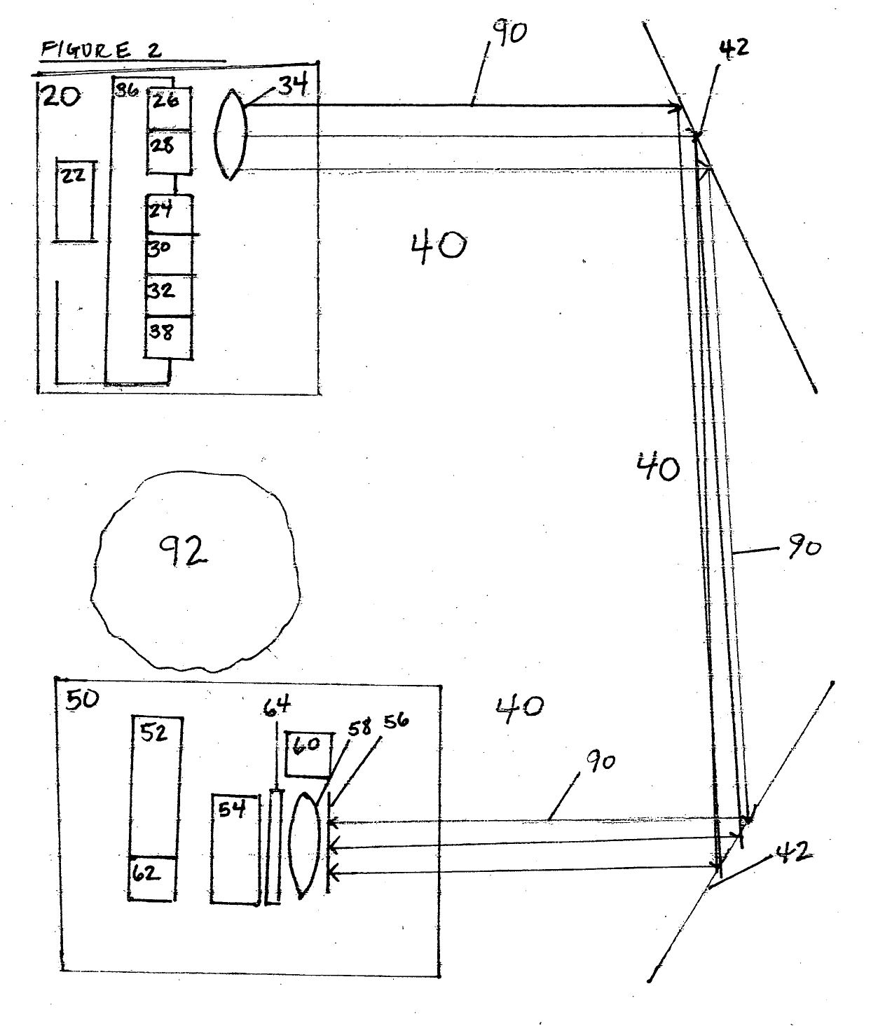

FIG. 2 shows a schematic diagram of preferred embodiment 1-A system.

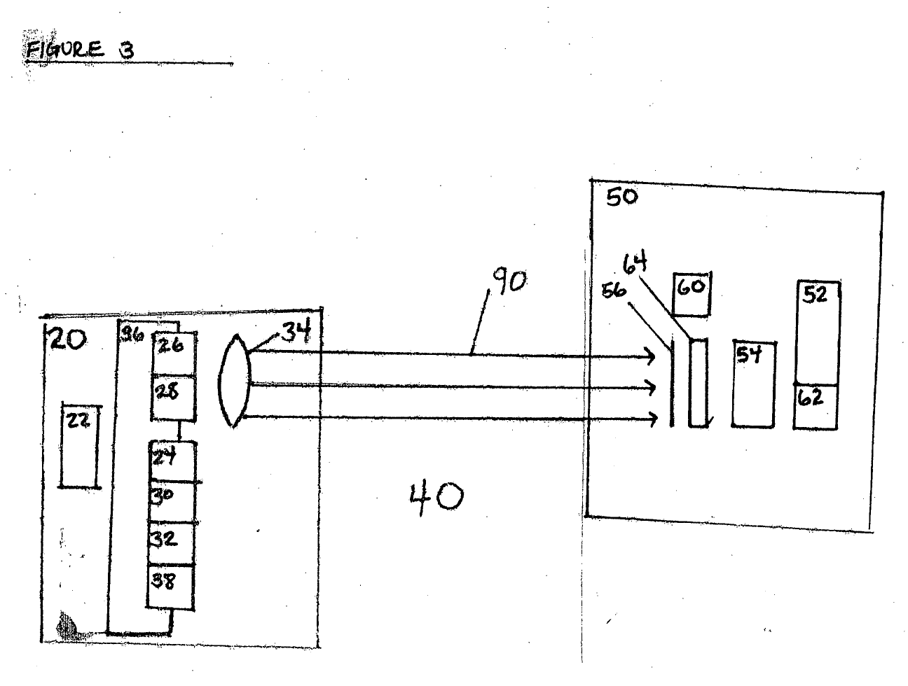

FIG. 3 shows a schematic diagram of preferred embodiment 1-B system.

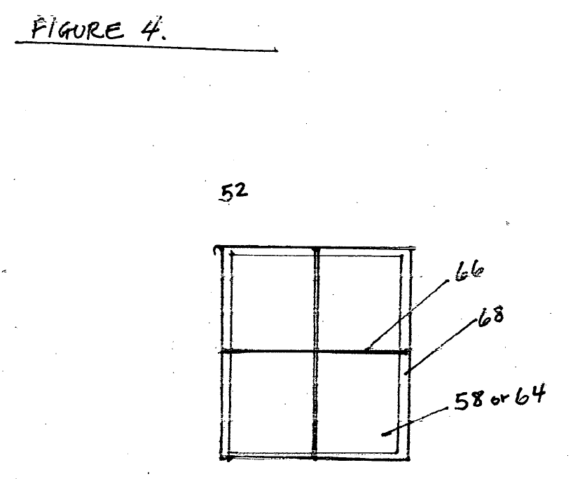

FIG. 4 shows the indicium on the front surface of the optical-to-electrical converter.

DRAWINGS - REFERENCE NUMBERS

| | | | |
|---|---|---|---|
| 10 | Search | 12 | Power Accounting |
| 14 | Turn On Laser(s) | | |
| 20 | transmitter assembly | 22 | CPU |
| 24 | camera | 26 | laser(s) |
| 28 | monitor photodiode(s) | 30 | illumination diode |
| 32 | signal photodiode | 34 | lens(es) |
| 36 | pointing mechanism | 38 | alignment laser |
| 40 | free space | 42 | mirror |
| 44 | pan and tilt mechanism | | |
| 50 | optical-to-electrical converter | 52 | CPU |
| 54 | power conversion photodiode(s) | 56 | indicium |
| 58 | optics | 60 | IR-LED |
| 62 | current and voltage circuit | 64 | optical diffusion layer |
| 66 | cross hair | 68 | perimeter |
| 90 | light | 92 | obstruction |

### DETAILED DESCRIPTION

FIG. 1 Method of Operation Flow Chart

Search 10. In embodiment 1A, the Camera 24 takes images. The images are parsed by the CPU 22, which is looking for the indicium 56 of the optical-to-electric converter 50. In Embodiment 1A, the load is stationary, like a lamp or television. In this embodiment, the user aims the laser(s) at the load and fixes it in place. In this embodiment, a low-power visible alignment laser is used for installation. In Embodiment 1B, the load may be anywhere in the room or may move during use, like a cell phone, laptop computer, or vacuum cleaner. In this embodiment, the Camera 24 scans the room to search for the load. Whether searching involves scanning the Camera 24 or continuously processing the same image, the search algorithm is similar.

To make this easier, the surface of the optical-to-electrical converter 50 has visible indicium 56 that are unlikely to exist on anything else. In the preferred embodiments, the indicium 56 is a box with a cross-hair. The indicium 56 is made from a retroreflective film to make it extremely visible when the transmitter assembly turns on its illumination diode 30, which operates at a wavelength that the camera is sensitive to. In the preferred embodiments, the camera is a CMOS camera, and a near IR illumination diode is used.

The last part of the search is the recognition handshake. The following steps are observed. In the preferred embodiments, when the CPU 22 believes the Camera 24 has seen an optical-to-electrical converter, it supplies a series of pulses of power to the Laser(s) 26. The optical-to-electrical converter 50 receives the power. The pulses are usually <10 milliseconds duration.

In the preferred embodiments, the optical-to-electrical 50 converter signals on back channel. In the preferred embodiments, the CPU 52 it then blinks a light such as an IR-LED 60. The signal is a train of optical pulses at >1 MHz. The signal photodiode 32 receives these signals. In the preferred embodiments, the optical-to-electrical converter signals its identity, its power requirement, safety information, its dimensions, and other information useful for operation.

In another embodiment the back channel is a radio-frequency transmitter, such as 802.11, and the signal photodiode 32 is replaced by a radio receiver. In this way there is a 2-way communication path. This path can be used to send any data, not just safety data. For example, music might be transmitted to audio speakers by modulating the lasers. This can be a digital or analog modulation.

Power Accounting 12. If the Search 10 is successful, the Camera 24 takes a series of images of the optical-to-electrical converter 50. CPU 22 then examines the beampath. CPU 22 examines the images of the beampath for shadows or bright areas, which suggest an interruption; CPU 22 examines the images of surface of the optical-to-electrical converter for scattering and retro-reflection. CPU 22 pulses Laser(s) 26. Optical-to-electrical converter 50 receives the pulses. Current and voltage circuit 62 provides data to CPU 52 on how much power was received by power conversion photodiode(s) 54, including amount of light and uniformity. CPU 22 has data from its own monitor photodiode(s) 28 on the power beamed from laser(s) 26.

The safety algorithm on CPU 22 makes a safety assessment. The safety assessment determines whether or not the system is complying with FDA or other regulations.

Turn On Laser(s) 14. In the preferred embodiments, the laser(s) 26 are on watchdog timers. They turn off automatically if the CPU 22 does not turn them on frequently. The CPU 22 can also turn them off. Power Accounting 12 runs continuously, turning on the lasers as long as it succeeds. When it fails, it returns to Search 10.

FIG. 2 Embodiment 1A

A preferred embodiment of the present invention is illustrated in FIG. 1A. This is for a system that might be used in a person's living room to illuminate a light attached to the ceiling. The load is assumed to require 20 Watts.

The preferred embodiment consists generally of transmitter assembly 20, free space 40, and optical to electrical converter 50.

Transmitter assembly 20 converts electricity to light. In the preferred embodiments, it uses an eye-safe diode laser(s) 26. These operate at >1500 nm wavelength. Such lasers are made by nLight Photonics, Inc, Princeton Lightwave, Covega, and other sources. Light 90 from the laser(s) 26 goes immediately into lens(es) 34 for focusing and pointing the lasers. In the preferred embodiment, the outgoing light 90 is nearly collimated, and the beam intensity is 1 mW/sq. mm-10 mW/sq.mm. The beam profile is substantially uniform.

The Transmitter assembly 20 must aim the light. To aim the light the pointing mechanism 36 is used. In Embodiment 1A this is just a simple mechanical pan-and-tilt operated by knobs that can be turned to aim it and then locked in place. A visible indicator laser 38 is used to facilitate pointing. Its beam is collimated and is parallel to the light 90.

In addition, as described above, camera 24, illumination diode 30, signal photodiode 32, and alignment laser 38, all are mounted substantially coaxially with light 90. Their field of view is substantially similar to and slightly larger than that of Laser(s) 26. In Embodiment 1A at 20 meters their field of view should be approximately 4× that of Laser(s) 26. In the preferred embodiments the camera 24 is a CMOS VGA camera, such as those made by Kodak, with a single plastic lens; the illumination diode is a near-IR VCSEL, such as the 850 nm VCSELs made by Truelight; the signal photodiode is a silicon photodiode; and the red laser is a collimated red VCSEL. CPU 22 can be any standard CPU sufficient to handle the data from the camera and the diodes. An ARM7-based microprocessor at >50 MHz is preferred.

Monitor photodiode(s) 28 is a germanium photodiode. It is mounted close to laser(s) 26 such that it receives the back-reflection from lens(es) 34.

In Embodiment 1A, Light 90 does not point in the direction of Optical-to-electrical converter 50. Obstruction 92 is in the path. Instead mirror 42 is in the path. In Embodiment 1A mirror 42 is just a small (75 mm×75 mm) mirror affixed to a pan and tilt mechanism 44 similar to pointing mechanism 36. Embodiment 1A, during installation, while alignment laser 38 is on, mechanism 44 is used to steer Light 90 and is then locked in place.

In Embodiment 1A, Optical-to-electrical converter 50 has indicium 56 on its front surface. The indicium 56 is a rectangular crosshair that surrounds the photodiodes. See FIG. 4. It is made of retroreflective material, such as that sold by 3M.

In Embodiment 1A optics 58 are the front surface. They focus light through diffusion layer 44, described in Safe Power Beaming System U.S. No. 40/678,577, and onto power conversion photodiode(s) 54. The power conversion photodiode(s) 54 is a GaSb photodiode(s) as provided by EdTek, Incorporated. The optics 58 is a Fresnel lens. All optics in this system should be coated for 1400 nm light. Focus-down should exceed 10-1. When more than one diode is used, the parallel-series arrangement of the diodes determines the output voltage and current.

In Embodiment 1A for safe operation as described above, a current and voltage circuit 62 monitors the power being received. A cpu 52 operates it and communicates with transmitter assembly 20 by modulating an IR-LED 64. The cpu can be an 8-bit CPU, such as those made by Microchip. IR-LED 64 is a 780 nm LED.

FIG. 3 Embodiment 1B

A preferred embodiment of the present invention is illustrated in FIG. 1B. This is for a system that might be used in a café or office to charge cell phones, laptops, etc. The load of a cell phone is 3-5 W and of a laptop 30-50 W. The elements are the same.

The elements of Embodiment 1B are the same as those for Embodiment 1A except as described here.

Transmit assembly 20 is assumed to be on the ceiling pointing downward for this embodiment. Obstruction 92 does not exist, so mirror 42 is not used. In embodiment 1B, the loads, the cell phones, place different requirements on the system.

Cell phones move, and may be anywhere. Pointing mechanism 36 is powered and controlled from the CPU 22. It may be a powered pan-and tilt system, as is commonly seen on security cameras. In an alternate embodiment, pointing mechanism 36 may be fixed, and an actuated mirror may be used to alter the beampath and allow the camera to scan.

Because the application requires thin, cheap electronics, power conversion photodiode(s) 54 in this embodiment are thin film diodes, not bulk diodes. Optics 52 are not used, and the optical system has no focus-down. So optical diffusion layer 64 is the front surface.

FIG. 4 Indicium

The indicium on the front surface of the optical-to-electrical converter is shown. Indicium 52 has cross hair 66 and perimeter 68. In the preferred embodiments, perimeter 68 is rectangular, but it may also be square. In preferred embodiment 1A it surrounds optics 58. In preferred embodiment 1B, it surrounds The cross-hair 66 should be approximately 1 mm wide. The perimeter 68 may be wider.

### CONCLUSION, RAMIFICATIONS, AND SCOPE

Accordingly, the reader will see that wireless power beaming is desireable in the same way that cellular telephones and other wireless networked devices are desireable. They allow people to move around while keeping their devices with them. They remove an impediment or inconveniece, the cord or the need to find a jack or outlet.

Although the description above contains many specificities, these should not be construed as limiting the scope of the invention but as merely providing illustrations of some presently preferred embodiment of this invention. For example, the sequence of steps in the method may be slightly altered. The positions of some of the elements may be shifted. Efficient light sources at very short eye-safe wavelengths may become available. Different loads require different combinations of elements for maximum usability and minimum cost.

The scope of this invention should be determined by the appended claims and their legal equivalents, rather than by the examples given.

I claim:

1. An apparatus to provide electricity to devices, the improvement wherein no wires are required to carry the electricity comprising:
a. an eye-safe light source that converts electricity to optical power beam,
b. optics and mechanics to shape and point the optical power beam beam at an optical-to-electric power converter,
c. free space
d. an optical-to-electric power converter
e. a safety subsystem that accounts for the optical power to within regulatory limits and controls when to beam is on or off to assure humans near to the light, as within a room, are exposed within regulatory limits.

2. The eye-safe light source in claim 1 comprising at least one laser outputting at wavelengths longer than 1400 nm.

3. The eye-safe laser eye-safe light source in claim 2 where the laser is an Indium Phosphide diode laser.

4. The means for focusing and pointing the light source in claim 1 consisting of lens(es).

5. The lens(es) in claim 4 where at least one lens is a Fresnel lens(es).

6. The optics and mechanics to shape and point said optical power beam beam consisting of a two-axis mechanical system.

7. The two axis mechanical system in claim 6 where the mechanical system is driven by motors.

8. The free space in claim 1 wherein the free space contains a mirror that redirects said optical power beam.

9. The optical-to-electric power converter from claim 1 containing a photodiode.

10. The optical-to-electric power converter from claim 1 wherein optics proximate to said focus said optical power beam onto said photodiode.

11. The safety subsystem from claim 1 wherein an optical diffusion layer of optical material proximate to said optical-to-electric power converter increases the angle of said optical power beam.

12. The safety subsystem in claim 1 wherein wherein a retroreflective film is proximate to or on the surface of said optical-to-electric power converter.

13. The safety subsystem in claim 1 wherein electricity to said eye-safe light source is controlled by a central processing unit.

14. The safety subsystem in claim 1 wherein a signaling device is proximate to said optical-to-electric power converter and a signal receiver is proximate to said eye-safe light source.

15. The safety subsystem in claim 1 wherein an electronic camera is proximate to said eye-safe light source.

16. The safety subsystem in claim 1 wherein an electrical current detector monitors said optical-to-electric power converter.

17. The safety subsystem in claim 1 wherein an electrical voltage detector monitors said optical-to-electric power converter.

18. The safety subsystem in claim 1 wherein a photodetector proximate to said safe light source monitors the level of said optical power beam.

19. The safety subsystem in claim 1 wherein an information channel from the optical-to-electrical converter to the transmitter assembly provides safety information in realtime.

20. The apparatus of claim 1 where the optical power beam is modulated providing a signal

21. A method for providing electricity to devices, the improvement wherein no wires are required to carry the electricity comprising:
a. searching for an optical-to-electrical converter
b. running a power accounting algorithm continuously
c. converting electricity to light and beaming said light across free space to said optical-to-electrical converter

22. the method in claim 21 where the optical power beam is expanded for safety such that its intensity remains <25 mW/sq.mm while it is in free space.

23. the method in claim 21 where the power accounting algorithm accounts for all transmitted energy to within regulatory standards and turns on or off the optical power beam accordingly.

24. the method in claim 21 where a camera is used to search for physical indicium.

25. the method in claim 21 where upon any safety breach condition, the power accounting algorithm causes the optical power beam to turn off so quickly that regulatory radiation exposure limits are maintained.

26. the method in claim 21 where the safety system maintains a communication channel between the central processing unit controlling said eye-safe light source and the central processing unit managing the optical-to-electrical converter

27. the method in claim 21 wherein, upon failure to receive information from the central processing unit managing the optical-to-electrical converter, the power accounting algorithm recognizes a safety breach condition.

28. the method in claim 21 wherein upon detection of a decrease in power received, the central processing unit managing the optical-to-electrical converter signals the power accounting algorithm of the safety breach.

29. the method in claim 21 wherein upon detection of an obstruction, the power accounting algorithm recognizes a safety breach.

30. the method in claim 21 wherein upon detection of an obstruction, the power accounting algorithm recognizes a safety breach.

31. the method in claim 21 wherein upon failure to account for light reflected according to snell's law from the surface of the detector, the power accounting algorithm recognizes a safety breach.

32. the method in claim 21 wherein upon failure to account for light scattered from the surface of the detector, the power accounting algorithm recognizes a safety breach.

33. the method in claim 21 wherein the power accounting algorithm tracks changes in optical power output in real-time and power reception by the optical-to-electrical converter.

34. the method in claim 21 wherein a mirror is used to change the direction of the optical power beam to avoid obstructions.
